(19) United States
(12) Patent Application Publication
(10) Pub. No.: US 2026/0313764 A1
(43) Pub. Date: Oct. 8, 2026

(54) ULTRA-EFFICIENT DIMMABLE LED DRIVER WITH SWITCHABLE LED LOAD

(71) Applicant: SIGNIFY HOLDING B.V., EINDHOVEN (NL)

(72) Inventors: THEO GERRIT ZIJLMAN, TILBURG (NL); WERNER FRIEDRICH HORIKX, EINDHOVEN (NL); ALEXANDER HENRICUS WALTHERUS VAN EEUWIJK, EINDHOVEN (NL); BERTRAND JOHAN EDWARD HONTELE, BREDA (NL); KARNEKUMAR ARULANDU, BREDA (NL); HAIMIN TAO, EINDHOVEN (NL)

(21) Appl. No.: 19/482,878

(22) PCT Filed: May 3, 2024
(86) PCT No.: PCT/EP2024/062350

§ 371 Date: Nov. 10, 2025

(30) Foreign Application Priority Data
May 11, 2023 (EP) 23172780.1

(51) Int. Cl. H05B 45/10

(52) U.S. Cl. CPC H05B 45/10

(57) ABSTRACT

The invention relates to a lighting apparatus comprising a light source having a parallel or a series configuration of a first sub-load and a second sub-load, a first driver adapted to provide power to the light source, a second driver adapted to provide power to the light source, a controller adapted to receive a dimming signal and adapted to allow or deny a power to be provided by the first driver and/or the second driver to the light source based on the dimming level and a control circuit adapted to receive a control signal, wherein the control circuit is arranged to activate and deactivate the first sub-load and the second sub-load based on the control signal.

### FIELD OF THE INVENTION

The invention relates to a lighting apparatus.

### BACKGROUND OF THE INVENTION

For the lighting industry, the requirements for energy efficiency become more challenging, especially with the new European Union energy labelling introduced on 1 Sep. 2021. This new labelling follows the trend of improvements in energy efficiency for lighting products. By then, more and more light sources achieved label ratings of A+ or A++, making it impossible for customers to see any light efficiency difference between products. With the new labelling, the light sources become more distributed over the labelling range again. This also means that lamps that were for example A++ rated in the old system are now labelled as C. It is therefore desired to further improve the energy efficiency of light sources.

Especially at dimmable light sources, there is a great desire to improve the efficiency. At dimming and especially deep dimming, the fixed losses in a driver e.g., losses caused in the control circuit, become a dominant part of the losses in a lighting apparatus. Drivers are generally designed for their rated power and the fixed losses are therefore also depending on the rated power of the driver. In general, a driver with a lower rated output power has also lower fixed power losses. This obviously impacts the total amount of power that can be provided to the load. A driver with a higher rated power can provide more power to its output, but this comes with more fixed losses. It is therefore desired to provide a lighting apparatus that can provide a good dimming function while operating at a very high efficiency.

### SUMMARY OF THE INVENTION

It is an objective of the invention to provide a lighting apparatus that has an improved efficiency while providing a dimming functionality.

To provide a solution, in a first aspect of the invention, a lighting apparatus is provided. The lighting apparatus comprises:
a light source having a parallel or a series configuration of a first sub-load and a second sub-load;
a first driver adapted to provide power to the light source;
a second driver adapted to provide power to the light source;
a controller adapted to receive a dimming signal and adapted to allow or deny a power to be provided by the first driver and/or the second driver to the light source based on the dimming level; and
a control circuit adapted to receive a control signal, wherein the control circuit is arranged to activate and deactivate the first sub-load and the second sub-load based on the control signal.

A lighting apparatus has a first driver and a second driver. Both drivers can provide power to the light source. The light source has an input and an output. Preferably, the drivers provide power to this input. Preferably, the input is the only input to the light source for providing power. The light source has a first sub-load and a second sub-load. The fist sub-load may be a first sub lighting load and the second sub-load may be a second sub lighting load. The lighting apparatus may receive a dimming signal, which may be received by the controller. Examples of dimming signals are phase-cut dimming signals, 0-10 V dimming signals, DALI dimming signals, DMX dimming signals or wireless dimming signals. The controller determines the amount of power that is to be provided to the light source. The controller therefore controls the first driver and the second driver to provide power to the light source based on the dimming level. Preferably, the controller may be used to allow or deny a driver to provide a power to the light source. By controlling the number of drivers that may provide power to the light source, the controller may regulate the amount of power to the light source. A control circuit is provided that is used to activate and deactivate the first sub-load and the second sub-load. The control circuit receives a control signal that provides the information for the control circuit which of the sub-loads is to be activated or deactivated. The controller is therefore used to determine the amount of power to be provided to the light source and the control circuit is used to determine how the power is distributed among the first sub-load and the second sub-load.

In a further example, the light source comprises a third sub-load and wherein the lighting apparatus comprises a third driver adapted to provide power to the light source, wherein the controller is further adapted to allow or deny power to be provided by the third driver, wherein the control circuit is further arranged to activate and deactivate the third sub-load.

A third driver and a third sub-load may be provided. The controller may then be arranged to control the third driver similar as the controller controls the first driver and the second driver. The lighting apparatus has therefore a third driver and a third sub-load. This allows more dimming steps to be provided, improving the resolution of the dimming. The lighting apparatus may have more that three drivers and three sub-loads. Preferably, the number of drivers is equal to the number of sub-loads.

In a further example, the control signal is provided by the controller.

Preferably, the control signal is provided by the controller. The controller may process the received dimming signal to derive the control signal. The control signal may then be provided to the control circuit. Instead of the controller, the control circuit may also receive the control signal from another source. As an example, the current to the light source may be used as a control signal, which allows the control circuit to determine which sub-loads are to be activated.

In a further example, the controller is arranged to allow power of the first driver to be provided to the light source and deny power of the second driver to be provided to the light source at a first dimming level.

At a first dimming level, the controller may determine that the first driver is allowed to provide power to the light source and the second driver is denied for providing power to the light source. When only two drivers are present, at the first dimming level, the first driver may be the only driver providing power to the light source.

In a further example, the control circuit is arranged to activate the first sub-load and deactivate the second sub-load.

Preferably, when the first driver provides power to the light source and the second driver does not provide power to the light source, the control circuit allows the first sub-load to be activated and the second sub-load to be deactivated. The lighting apparatus is then arranged to provide power using the first driver. The power is then provided to the first sub-load. This allows the power provided by the first driver to be optimized with the power that can be consumed by the first sub-load. In the example where only two drivers are provided, the first driver may then provide power to only the first sub-load.

In a further example, a current provided by the first driver corresponds to an optimal current density of the first sub-load.

It is preferred that the power provided by the first driver to the first sub-load provides a current to the first sub-load that corresponds to an optimal current density of the first sub-load. When providing the optimal current density to the first sub-load, the first sub-load provides light at its optimum efficiency. In this example, the lighting apparatus provides at the first dimming level a light output lower than the maximum capable light output. The light output is provided at a relatively high efficiency. Preferably, the first driver is arranged to provide the power providing the optimal current density at its own highest efficiency. Therefore, the lighting apparatus operating at the first dimming level has a driver and sub-load active at relative high efficiencies.

In a further example, the controller is arranged to deny power of the first driver to be provided to the light source and allow power of the second driver to be provided to the light source at a second dimming level.

At a second dimming level, the controller may determine that the first driver is denied providing power to the light source and the second driver is allowed to provide power to the light source. When only two drivers are present, at the second dimming level, the second driver may be the only driver providing power to the light source.

In a further example, the control circuit is arranged to deactivate the first sub-load and activate the second sub-load.

Preferably, when the first driver does not provide power to the light source and the second driver provides power to the light source, the control circuit allows the second sub-load to be activated and the first sub-load to be deactivated. The lighting apparatus is then arranged to provide power using the second driver. The power is then provided to the second sub-load. This allows the power provided by the second driver to be optimized with the power that can be consumed by the second sub-load. In the example where only two drivers are provided, the second driver may then provide power to only the second sub-load.

In a further example, a current provided by the second driver corresponds to an optimal current density of the second sub-load.

It is preferred that the power provided by the second driver to the second sub-load provides a current to the second sub-load that corresponds to an optimal current density of the second sub-load. When providing the optimal current density to the second sub-load, the second sub-load provides light at its optimum efficiency. In this example, the lighting apparatus provides at the second dimming level a light output lower than the maximum capable light output. The light output is provided at a relatively high efficiency. Preferably, the second driver is arranged to provide the power providing the optimal current density at its own highest efficiency. Therefore, the lighting apparatus operating at the second dimming level has a driver and sub-load active at relative high efficiencies.

In a further example, a maximum power capability of the first driver is approximately identical to a maximum power capability of the second driver.

As an example, the first driver and the second driver are arranged such that they can provide an identical maximum power to the light source. This means in the example of two drivers that each driver can provide 50% of the maximum power that can be provided to the light source. The design of the lighting apparatus can be simplified by providing identical drivers, as many as desired, in a simple and modular way.

In another example a maximum power capability of the first driver is lower than a maximum power capability of the second driver.

As an example, the first driver has a maximum power capability that is lower than the maximum power capability of the second driver.

When the first driver has a maximum power capability that is lower than the maximum power capability of the second driver, this allows the first driver to provide a lower power at the first dimming level than the second driver at the second dimming level. Non-linear diming steps may be introduced this way. Another benefit may be that additional dimming steps with different light outputs may be provided for the lighting apparatus. As an example, the first sub-load may have a smaller maximum power capability than the second sub-load. The first driver may therefore provide less power to the first sub-load than the second driver would provide to the second sub-load. Therefore, the power provided at the first dimming level may be lower than the power provided at the second dimming level. A third dimming level may be at e.g. maximum power to the light source where both drivers provide power to the light source.

In a further example, the first driver and the second driver are non-dimmable drivers.

It is desired that for providing a very energy efficient lighting apparatus, the drivers are non-dimmable drivers. The drivers are designed to provide a single amount of power. The drivers may therefore be optimized to provide this single amount of power at its highest efficiency. Therefore, when a driver is active, the driver is always active at its highest efficiency.

In a further example, light generated by the first sub-load is emitted at a first surface and light generated by the second sub-load is emitted at a second surface, wherein the first surface at least partly does not overlap with the second surface.

As an addition or alternative to changing light intensity, colour or colour temperature of the light sources, a beam shaping mechanism can be introduced. When the first light source emits light at a surface that is different from a surface upon which the second light source emits, the dimming levels can be used for lighting different surfaces. The overall beam angle of a lighting device can be adjusted based on the dimming level.

### BRIEF DESCRIPTION OF THE DRAWINGS

Examples of the invention will now be described with reference to the accompanying drawings, in which:

FIG. 1 shows an example of a circuit diagram.

FIG. 2 shows another example of a circuit diagram.

FIG. 3 shows a graph of a relation between output power and dimming level.

FIG. 4 shows another graph of a relation between output power and dimming level.

FIG. 5 shows another example of a circuit diagram.

FIG. 6 shows another graph of a relation between output power and dimming level.

FIG. 7 shows another graph of a relation between output power and dimming level.

FIG. 8 shows another example of a circuit diagram.

FIG. 9 shows another example of a circuit diagram.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should also be understood that the Figures are merely schematic and are not drawn to scale. It should also be understood that the same reference numerals are used throughout the Figures to indicate the same or similar parts.

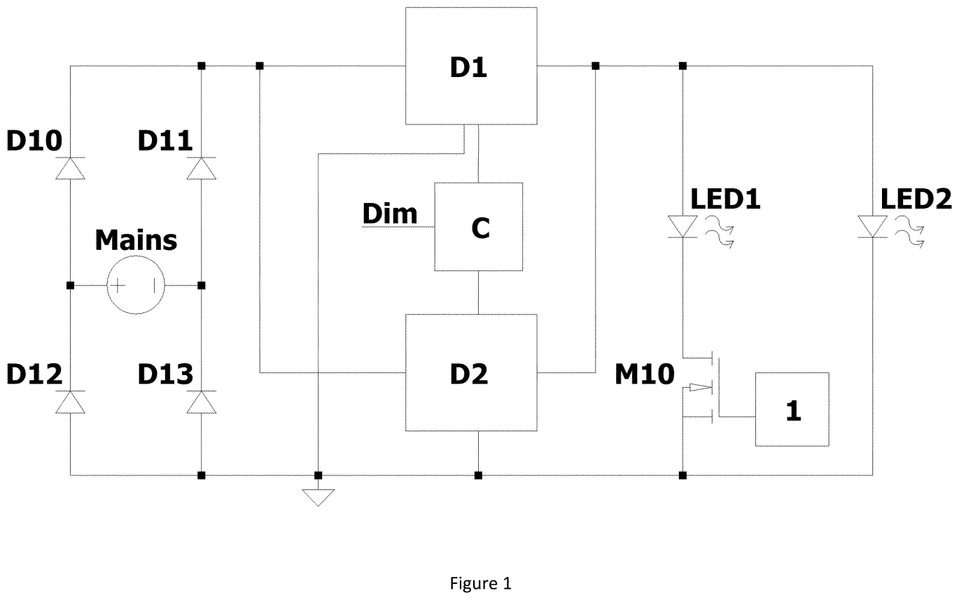

FIG. 1 shows an example of a circuit diagram of a lighting apparatus having a driver circuit that provides an output power to the light source. The driver circuit may be coupled to mains via a rectifier circuit having four diodes D10, D11, D12 and D13. The rectifier circuit provides a rectified mains voltage. In the example provided, a first driver D1 and a second driver D2 receive the rectified mains voltage. A controller C is used to control the first driver D1 and the second driver D2. The controller C may receive a dimming signal Dim. The dimming signal Dim may be provided by a dimmer or an external device providing dimming commands. Examples of devices that can provide the dimming signal are phase-cut dimmers, 0-10 V dimmers, DALI dimmers, DMX dimmers or wireless remote devices for providing dimming signals. The first driver D1 and the second driver D2 are arranged to provide power to the same light source.

The light source has a first input to which the output of the first driver D1 and the output of the second driver D2 are coupled. Preferably, the light source is an LED light source. The LED light source may be a string of LEDs coupled in series, preferably forming a filament. Other devices or a combination of devices may also be coupled in series such as laser diodes or VCSEL. For the sake of clarity, the examples show LEDs as the light source.

The controller C receives the dimming signal and uses this dimming signal for providing control signals for the first driver D1 and the second driver D2. Preferably, the controller C converts the dimming signal into discrete dimming levels. The controller C may base the number of discrete dimming levels on the number of drivers provided in the driver circuit. In the example of drivers having identical rated powers, the number of discrete dimming levels may be determined by the equation: D=1+N, where D is the number of discrete dimming levels and N is the number of drivers. In the example where two drivers are provided, the number of discrete dimming levels is 3. The dimming signal has a dimming range from 0% to 100%. The controller C reads the dimming signal and based on the value of the dimming signal, discrete dimming levels are generated. The discrete dimming levels are then set at 0% output power, 50% output power and 100% output power. In this example, a dimming signal between 0% and 25% may be converted into 0% as a discrete dimming level. A dimming signal between 26% and 75% may be converted into 50% as a discrete dimming level. A dimming signal between 76% and 100% may be converted into 100% as a discrete dimming level. It is clear that these values are merely one example of how to convert the dimming range of the dimming signal into discrete dimming levels and that other ranges for converting the dimming signal into the discrete dimming levels are conceivable. At 0% output power, the controller provides control signals to the drivers preventing the first driver D1 and the second driver D2 to provide power to the light source. Both drivers may be turned off. At 50% of the output power, the controller C provides control signals to the drivers allowing one of the drivers to provide the rated power to the load and preventing the other driver to provide power to the load. At 100% of the output power, the controller C provides control signals to the drivers allowing both drivers to provide their rated power to the light source.

At all dimming levels, the lighting apparatus is now capable of operating at the highest efficiency possible. When less than the maximum number of drivers provide power to the light source, the light efficacy may even further be improved.

The light source is provided with a first sub-load LED1 and a second sub-load LED2. The first sub-load LED1 has a first lighting load, which is shown as an LED load in this example. The number of LEDs can be chosen such as is desired for any design. LEDs can be placed in series or in parallel or in a combination thereof. In series with the first lighting load is a first switching element M10. The first switching element M10 is shown as a MOSFET, but other type of switching elements are also possible. Examples of switching elements are transistors and relays. The first switching element is controlled by a control circuit 1. The second sub-load LED2 has a second lighting load LED2, which is shown as an LED load in this example. The number of LEDs can be chosen such as is desired for any design. LEDs can be placed in series or in parallel or in a combination thereof. The control circuit 1 is used to control the first switching element M10. The control circuit 1 is therefore arranged to regulate the distribution of the power provided by the drivers to the sub-loads.

As an example, when the first switching element M10 is closed, all current may flow through the first sub-load LED1 and no power will flow through the second sub-load LED2. Therefore, any power provided by any of the drivers will be provided to the first sub-load LED1. This may especially be the case when the forward voltage of the first sub-load LED1 is lower than the forward voltage of the second sub-load LED2. As an example, it may be desired that when the first driver D1 provides power to the light source, the control circuit 1 closes the first switching element M10, allowing all the power provided by the first driver D1 to be provided to the first sub-load LED1, while no power is provided to the second sub-load LED2. In this example, the second driver D2 does not provide any power to the light source.

When the first switching element M10 is open, no current can flow through the first sub-load LED1. Therefore, any power provided by any of the drivers will be provided to the second sub-load LED2. As an example, it may be desired that when the second driver D2 provides power to the light source, the control circuit 1 opens the first switching element M10, allowing all the power provided by the second driver D2 to be provided to the second sub-load LED2, while no power is provided to the second sub-load LED1. In this example, the first driver D1 does not provide any power to the light source.

Preferably, the first driver D1 is arranged to provide the power at its rated power. This means that the first driver D1 provides power at a very high efficiency. Even more preferably, the first sub-load LED1 is designed to receive this rated power and convert this rated power at a very high efficiency. This means that the optimum current density of the first sub-load LED1 is matched with the current that is provided by the first driver LED1. In this example it may be desired that the first driver D1 is arranged to provide power only at the rated power level. This means that the first driver D1 is a non-dimmable driver and can therefore only output a single amount of power.

Preferably, the second driver D2 is arranged to provide the power at its rated power. This means that the first driver D2 provides power at a very high efficiency. Even more preferably, the second sub-load LED2 is designed to receive this rated power and convert this rated power at a very high efficiency. This means that the optimum current density of the second sub-load LED2 is matched with the current that is provided by the second driver LED2. In this example it may be desired that the second driver D2 is arranged to provide power only at the rated power level. This means that the second driver D2 is a non-dimmable driver and can therefore only output a single amount of power.

As an example, the first driver D1 and the second driver D2 may be arranged to provide power to the light source simultaneously. This may be done to provide the maximum power to the light source at e.g., 100% dimming level. Preferably, the first sub-load LED1 and the second sub-load LED2 are designed such that when the when both drivers are powering the light source, and the control circuit 1 closes the first switching element M10, they provide a proper distribution of the total power between the first sub-load LED1 and the second sub-load LED2. This may be done by ensuring that the forward voltage of the first sub-load LED1 together with the voltage across the first switching element M10 is matched with the forward voltage of the second sub-load LED2.

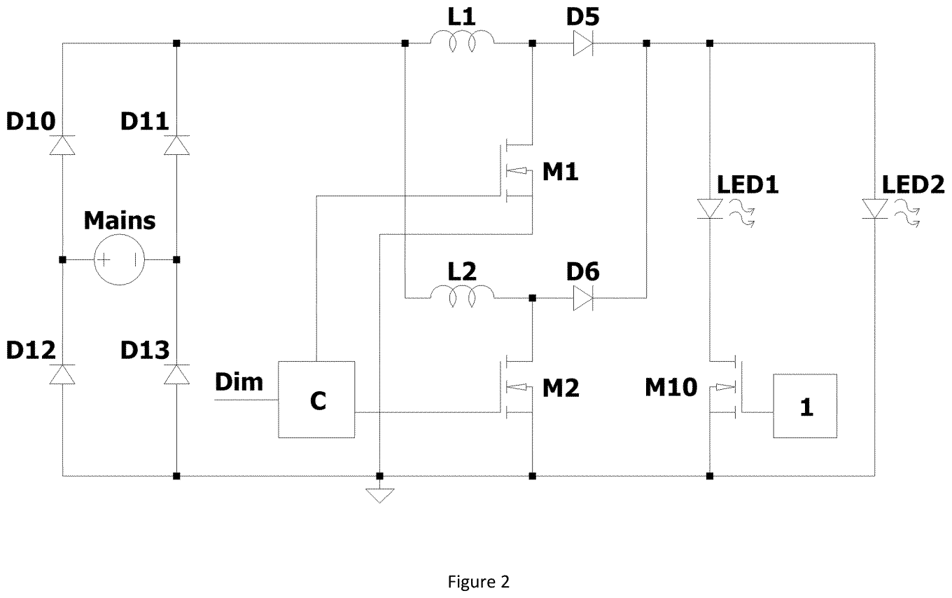

FIG. 2 shows an example of a detailed circuit diagram of the circuit shown in FIG. 1. In the example provided, a rectifier circuit D10, D11, D12, D13 is provided. The rectifier circuit provides a rectified voltage which is provided to the first driver D1 and the second driver D2. The first driver D1 and the second driver D2 are designed as boost converters. The first driver D1 and the second driver D2 are coupled in parallel at their inputs and provide a parallel power to the light source. The first driver D1 has a first inductor L1, a first switching element M1 and a first diode D5. The second driver D2 has a second inductor L2, a second switching element M2 and a second diode D6. The first diode D5 and second diode D6 provide two functions. The diodes form the freewheel diodes for the boost converter topology and they allow the outputs of the first driver D1 and the second driver D2 to be coupled together. In the case that another topology than the boost converter, e.g. a buck converter, an additional diode may be needed for each driver to allow the drivers to be coupled at their outputs. The controller C provides control signals for the first driver D1 and the second driver D2. In this example, the control signals may be directly provided at the gate of the first switching element M1 and the second switching element M2 respectively. The controller C therefore determines the power that can be delivered to the light source. Preferably, the controller C controls the drivers such that the power provided to the light source corresponds to power required for the light source according to the discrete dimming levels.

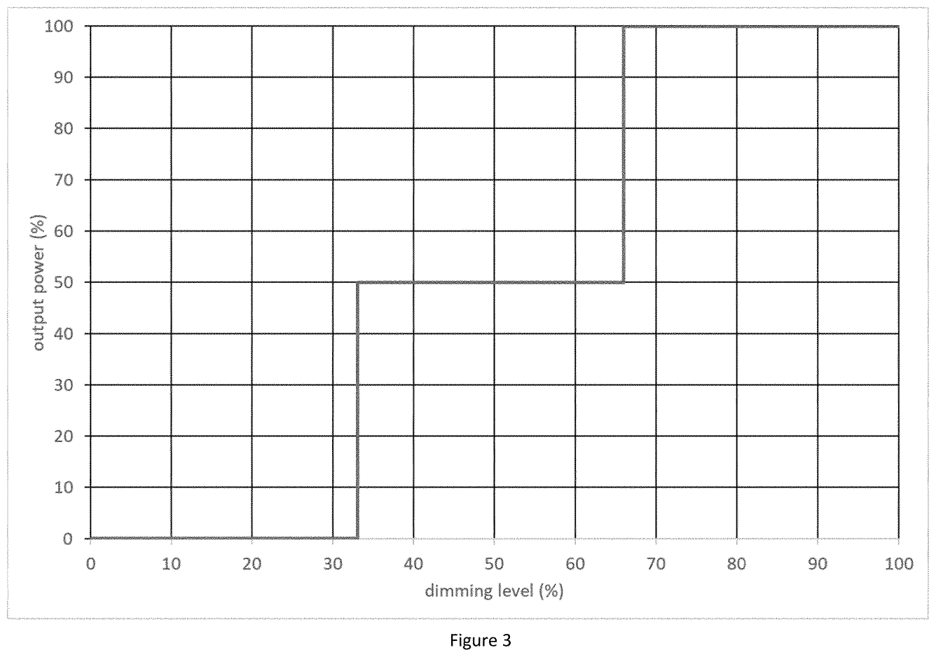

FIG. 3 shows a graph of the relation of the dimming level and the output power of the drivers when two drivers, having approximately equal power ratings, are provided. The dimming signal is received by the controller C and is interpreted as a dimming level. The controller determines the discrete dimming levels based on the dimming level. In this example it can be seen that there are three discrete dimming levels, one at 0% output power, one at 50% output power and the last one at 100% output power. In this example, the controller C determines that between a dimming level of 0% and 33%, the discrete dimming level is set at 0% output power. Between a dimming level of 34% and 66%, the discrete dimming level is set at 50%. Between 67% and 100%, the discrete dimming level is set at 100%. This means that in the dimming range of 0% and 33%, no power is provided to the light source. Between a dimming level of 34% and 66%, 50% output power is provided to the light source. The controller C activates one driver to provide the rated power to the light source, corresponding to the 50% output power, and inhibits the other driver to power the light source. Between a dimming level of 67% and 100%, 100% of the output power is provided to the light source. The controller C activates both drivers to provide their rated powers to the light source, which corresponds to 100% of the output power. It is clear that other relations between the dimming level and the discrete dimming levels can be derived, while keeping the same discrete dimming levels.

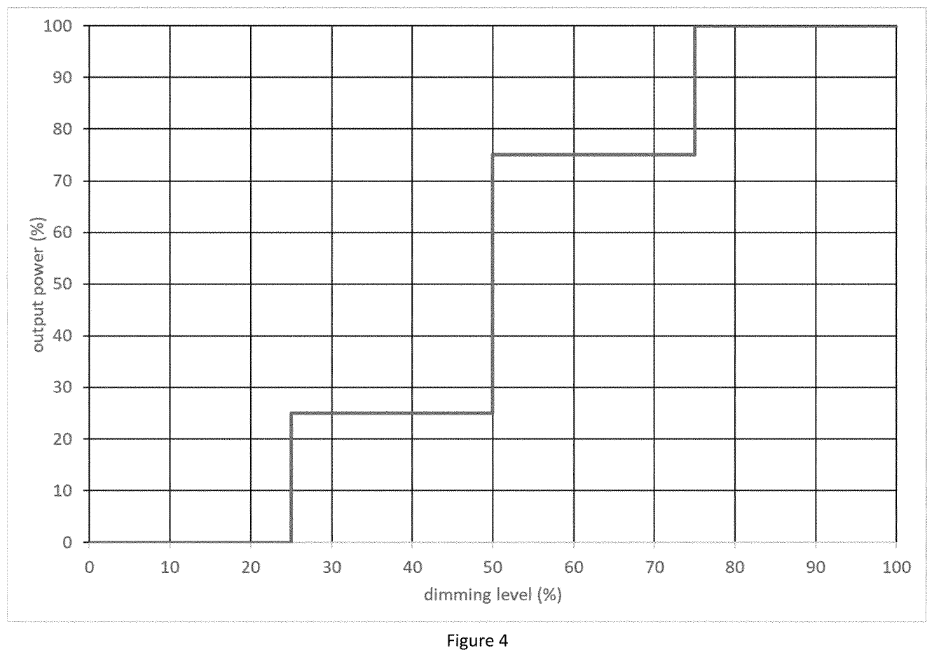

FIG. 4 shows a graph of the relation of the dimming level and the output power of the driver circuit when two drivers, having different power ratings, are provided. The dimming signal is received by the controller C and is interpreted as a dimming level. The controller C determines the discrete dimming levels based on the dimming level. In this example it can be seen that there are four discrete dimming levels, one at 0% output power, one at 25% output power, one at 75% output power and the last one at 100% output power. The number of discrete dimming levels may be derived from the equation D=N(N+1)/2+1, where D is the number of discrete dimming levels and N is the number of drivers. As an example, the first driver D1 is arranged to have a rated power of 1 W and the second driver D2 is arranged to have a rated power of 3 W. When both drivers are not providing power to the light source, the power to the light source is 0 W, which is related to a dimming level between 0% and 24%. When only the first driver D1 provides power to the light source at its rated power, the light source receives 1 W, which corresponds to 25% of the total output power. This output power is then related to a dimming level between 25% and 50%. When only the second driver D2 provides power to the light source at its rated power, the light source receives 3 W, which corresponds to 75% of the total output power. This output power is then related to a dimming level between 51% and 75%. The total rated power of the driver circuit is 4 W, which corresponds to the output power at a dimming level between 76% and 100%, where both the first driver D1 and the second driver D2 provide power to the light source at their respective rated powers.

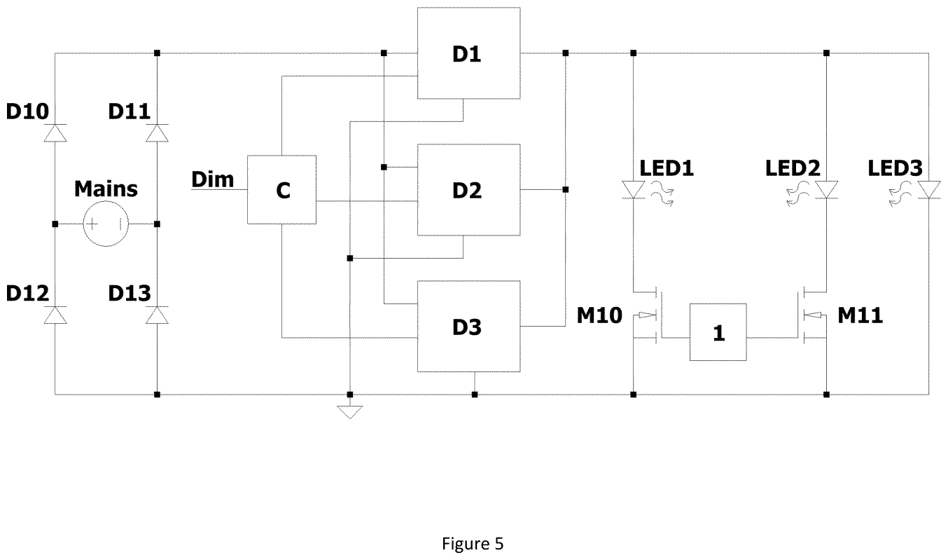

FIG. 5 shows an example of a circuit diagram of a lighting apparatus. The lighting apparatus has an additional driver. The driver circuit has a first driver D1, a second driver D2 and a third driver D3. In the example provided, a rectifier circuit D10, D11, D12, D13 is provided. The rectifier circuit provides a rectified voltage which is provided to the first driver D1, the second driver D2 and the third driver D3. The first driver D1, the second driver D2 and the third driver D3 are coupled in parallel at their inputs and provide a parallel power to the light source. The controller C provides control signals for the first driver D1, the second driver D2 and the third driver D3. The controller C therefore determines the power that can be delivered to the light source. Preferably, the controller C controls the drivers such that the power provided to the light source corresponds to the power required for the light source according to the discrete dimming levels. Preferably, the lighting apparatus has a third sub-load LED3 that is placed in parallel with the other sub-loads. In this example, the first sub-load LED1 is coupled in series with a first switching element M10. The second sub-load LED2 is coupled in series with a second switching element M11. In this example, the third sub-load LED3 is not coupled in series with a switching element, but it may be an option to couple the third sub-load LED3 in series with a switching element. When the first switching element M10 is closed and the second switching element M11 is open, the sub-loads may be configured such that the drivers provide power only to the first sub-load LED1. When the first switching element M10 is open and the second switching element M11 is closed, the sub-loads may be configured such that the drivers provide power only to the second sub-load LED2. When the first switching element M10 and the second switching element M11 are open, no current can flow through the first sub-load LED1 and the second sub-load LED2. Therefore, any power provided by the drivers is provided to the third sub-load LED3. Providing a switching element in series with the third sub-load LED3 allows a better control of power distribution between the sub-loads.

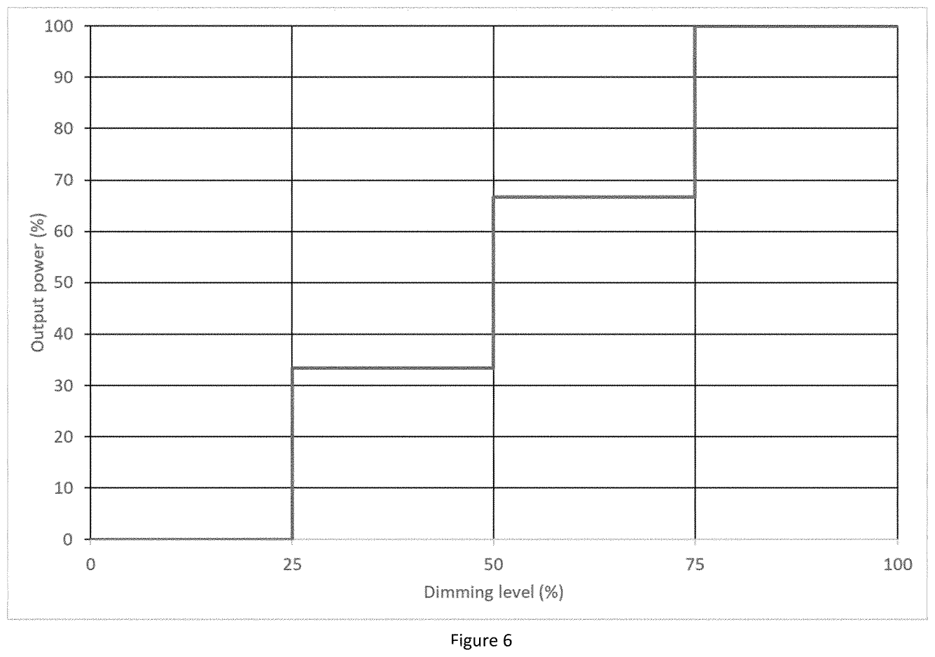

FIG. 6 shows an example of a graph of the relation between the dimming level and the output power of the drivers when three drivers are provided. In this example, it is assumed that the drivers have an approximate identical rated power. In this example, four discrete dimming levels are derived, namely 0%, 33.33%, 66.67% and 100%. At a dimming level between 0% and 24%, the discrete dimming level is set at 0%, resulting in no power to be provided to the light source. At a dimming level between 25% and 50%, the discrete dimming level is set at 33.33%, resulting in the controller C controlling one driver to provide power to the light source at the corresponding rated power of that driver. This results in that 33% of the total power that can be provided by the driver circuit is provided to the light source LED. At a dimming level between 26% and 75%, the discrete dimming level is set at 66.67%, resulting in the controller C controlling two of the three drivers to provide the power to the light source at the corresponding rated powers of the drivers. This results in that 66.67% of the total power that can be provided by the driver circuit is provided to the light source. At a dimming level between 76% and 100%, the discrete dimming level is set at 100%, resulting in the controller C controlling all drivers to provide power to the light source LED at the corresponding rated powers of the drivers. This results in that 100% of the total power that can be provided by the driver circuit is provided to the light source.

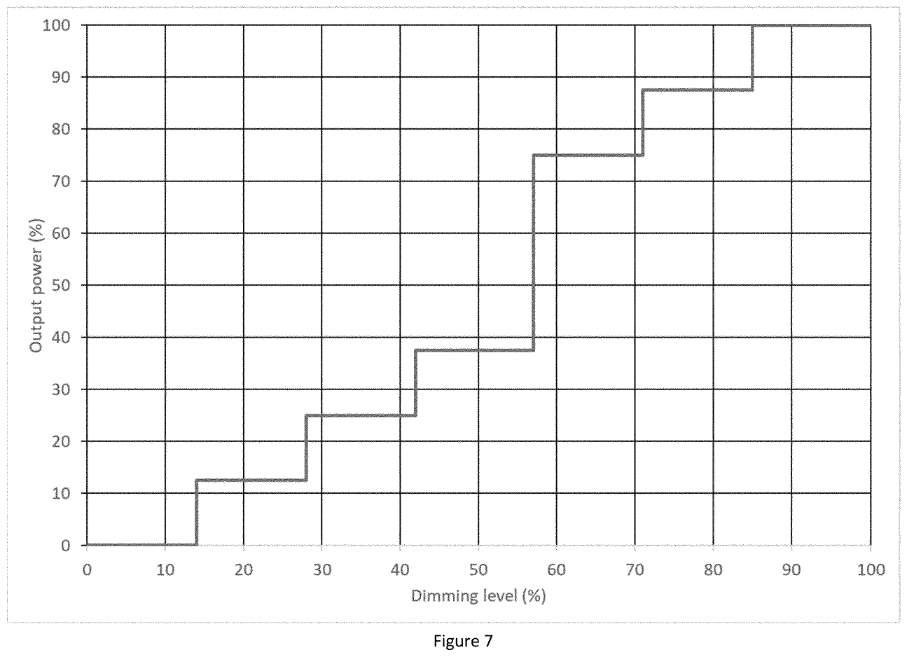

FIG. 7 shows an example of a graph of the relation between the dimming level and the output power of the drivers when three drivers are provided. In this example, it is assumed that the drivers have different rated powers. In this example, seven discrete dimming levels may be derived, namely one at 0% output power, one at 12.5% output power, one at 25% output power, one at 37.5% output power, one at 75% output power, one at 87.5% output power and the last one at 100% output power. As an example, the first driver D1 may have a rated power of 1 W, the second driver D2 may have a rated power of 2 W and the third driver D3 may have a rated power of 5 W, resulting in a maximum power that can be provided by the drivers of 8 W. In this example, at a dimming level between 0% and 14.3%, the discrete dimming level is set at 0%, resulting in no power to be provided to the light source. At a dimming level between 14.4% and 28.6%, the discrete dimming level is set at 12.5%, resulting in power to be provided to the light source by only the first driver D1 at the rated power of the first driver D1. When only the first driver D1 provides power to the light source at its rated power, the light source receives 1 W, which corresponds to 12.5% of the total output power. Preferably, the first driver D1 provides the 1 W of power to the first sub-load LED1. Preferably, the first sub-load LED1 has an optimum light generation at 1 W. The current provided by the first driver D1 may provide a current density for the first sub-load LED1 that is close to the optimum current density for the first sub-load LED1. At a dimming level between 28.7% and 42.9%, the discrete dimming level is set at 25%, resulting in power to be provided to the light source by only the second driver D2 at the rated power of the second driver D2. When only the second driver D2 provides power to the light source at its rated power, the light source receives 2 W, which corresponds to 25% of the total output power. Preferably, the second driver D2 provides the 2 W of power to the second sub-load LED2. Preferably, the second sub-load LED2 has an optimum light generation at 2 W. The current provided by the second driver D2 may provide a current density for the second sub-load LED2 that is close to the optimum current density for the second sub-load LED2. At a dimming level between 43% and 57.1%, the discrete dimming level is set at 37.5%, resulting in power to be provided to the light source only by the first driver D1 and the second driver D2 at the rated powers of the first driver D1 and the second driver D2. At a dimming level between 57.2% and 71.4%, the discrete dimming level is set at 75%, resulting in power to be provided to the light source by only the first driver D1 and the third driver D3 at the rated powers of the first driver D1 and the third driver D3. At a dimming level between 71.5% and 85.7%, the discrete dimming level is set at 87.5%, resulting in power to be provided to the light source by only the second driver D2 and the third driver D3 at the rated powers of the second driver D2 and the third driver D3. At a dimming level between 85.8% and 100%, the discrete dimming level is set at 100%, resulting in power to be provided to the light source by first driver D1, the second driver D2 and the third driver D3 at the rated powers of the first diver D1, the second driver D2 and the third driver D3. In an example where only the third driver provides power to the light source, the third driver D3 provides the 5 W of power to the third sub-load LED3. Preferably, the third sub-load LED3 has an optimum light generation at 5 W. The current provided by the third driver D3 may provide a current density for the third sub-load LED3 that is close to the optimum current density for the third sub-load LED3.

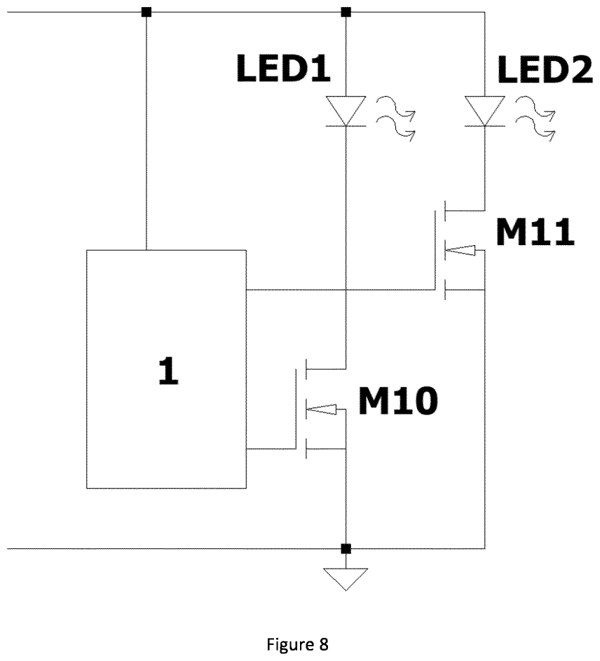

FIG. 8 shows an example of a circuit diagram where an improved light source is provided that can operate with the driver circuit as provided in the examples. The light source LED receives power from the drivers. The light source has a first sub-load LED1 and a second sub-load LED2. The first sub-load LED1 and the second sub-load LED2 are coupled in parallel. Preferably, the first sub-load LED1 and the second sub-load LED2 have an approximately identical forward voltage. Preferably, the first sub-load LED1 and the second sub-load LED2 are provided as filaments. The first sub-load LED1 and the second sub-load LED2 are shown as single LEDs but more LEDs can be coupled in series as to form a string of LEDs or a filament. A first switching element M10 is provided in series with the first sub-load LED1. A second switching element M11 is provided in series with the second sub-load LED2. A control circuit 1 is arranged to control the first switching element M10 and the second switching element M11. The control circuit 1 is arranged to sense a parameter of the voltage or current provided by the drivers. Examples of the parameters may be a frequency, a duty cycle or an amplitude of the voltage or current. The parameter is used by the control circuit 1 to determine how the first switching element M10 and the second switching element M11 are controlled. As an example, a frequency modulation on the voltage or current provided by the drivers may provide information for the control circuit 1 to determine which of the switching elements is to be controlled. As an example, a frequency modulation of 1 kHz may provide an indication for the control circuit 1 to close the first switching element M10 and open the second switching element M11, where a 2 kHz modulation may cause the first switching element M10 to open and the second switching element M11 to close and a 3 kHz modulation may cause the first switching element M10 to close and the second switching element M11 to close. As another example, a similar control can be provided by changing the amplitude of the voltage or the current provided by the drivers. A change in voltage or current may change the control of the first switching element M10 and the second switching element M11. An advantage of control of the light source configuration according to the above-mentioned examples is that with only two wires, power and data can be sent from the drivers to the light source, which is especially beneficial when the light source is designed as a filament in a bulb, such as a retrofittable bulb with e.g. a screw or bayonet base. In such situation, the number of wires that can be provided through the stem may be limited. Using the dimming technique provided in the examples allow an easy dimming of the filaments, while the control circuit 1 allows to distribute the provided power among the filaments. Preferably, the first sub-load LED1 and the second sub-load LED2 have different colors or colour temperatures from each other. Preferably, the first sub-load LED1 has a warm colour temperature and the second sub-load LED2 has a cold colour temperature. The parameter can therefore be used to allow the control circuit 1 to regulate the colour or colour temperature that is emitted by the light source. The opening and closing of the first switching element M10 and the second switching element M11 can be a time continuous process where either the first switching element M10 is closed or the second switching element M11 is closed, each with their own duty cycle e.g., a PWM control. Preferably, this switching process is performed with a frequency above 100 Hz and more preferably above 2 kHz. Alternatively, to provide for a simple control for the control circuit 1, the opening and closing of the first switching element M10 and the second switching element M11 can be a single event, e.g. at start-up of the lighting apparatus. During operation, the open or closed state of the first switching element M10 and the second switching element M11 can be altered by a different command, e.g. a command for changing the colour or colour temperature.

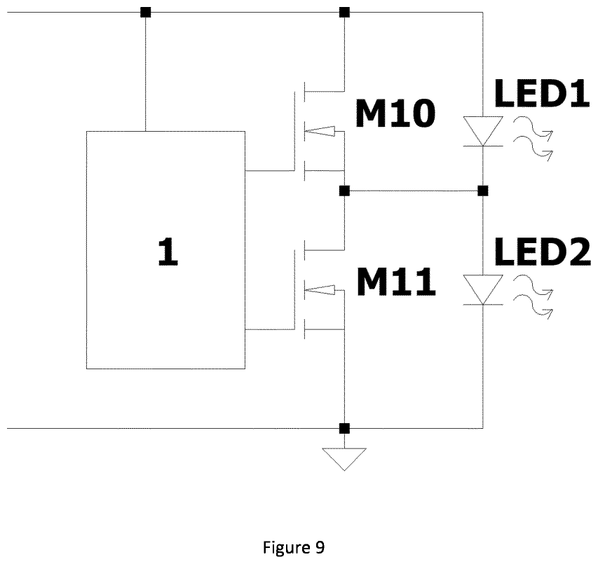

FIG. 9 shows an example of a circuit diagram where an improved light source is provided that can operate with the driver circuit as provided in the examples. The first sub-load LED1 is coupled in series with the second sub-load LED2. The series configuration of the first sub-load LED1 and the second sub-load LED2 is coupled between outputs of the drivers. The first switching element M10 is coupled in parallel with the first sub-load LED1. The second switching element M11 is coupled in parallel to the second sub-load LED2. The switching elements may act as shunt switches, when closed effectively shunting the corresponding parallel sub-load. A control circuit 1 is provided to control the first switching element M10 and the second switching element M11. The control circuit 1 may comprise multiple components for different purposes, e.g. controlling the first switching element M10 and the second switching element M11. The control circuit 1 may be an integral part of the controller C.

Preferably, when the first sub-load LED1 and the second sub-load LED2 provide a similar light output, the number of dimming steps are based on the number of sub-loads and corresponding switching elements that are provided. In the example provided, two sub-load are provided. There are three discrete dimming steps available. One discrete dimming step can be set at 0% output power, another discrete dimming step may be set at 33% output power, another discrete dimming step may be set at 66% output power and another discrete dimming step may be set at 100% output power. In this case, the drivers may be configured to generate no current such that no light source is powered at the dimming step of 0% output power.

The control circuit 1 may be arranged to control the first switching element M10 and the second switching element M11 based on the discrete dimming level. The drivers may be arranged to regulate the current to the light source based of the discrete dimming level. The drivers may receive the discrete dimming signal from the controller C. The teachings provided in the examples where the sub-loads are coupled in parallel may also apply to the teachings in this example, where the sub-loads are coupled in series.

When the first switching element M10 is open and the second switching element M11 is closed, the drivers provide a first current to the first sub-load LED1. The second sub-load LED2 is shunted by the second switching element M11 and therefore no current flows through the second sub-load LED2. Opening the first switching element M10 and closing the second switching element M11 may therefore be implemented at the first discrete dimming level.

When the first switching element M10 is open and the second switching element M11 is open, the drivers provide a first current to the first sub-load LED1 and a second current to the second sub-load LED2. The first sub-load LED1 and the second sub-load LED2 are not shunted by the first switching element M10 and the second switching element M11 respectively and therefore current flows through the first sub-load LED1 and the second sub-load LED2. Opening the first switching element M10 and opening the second switching element M11 may therefore be implemented at a second discrete dimming level.

When the first switching element M10 is closed and the second switching element M11 is opened, the drive provide a second current to the second sub-load LED2. The first sub-load LED1 is shunted by the first switching element M10 and therefore no current flows through the first sub-load LED1. Closing the first switching element M10 and opening the second switching element M11 may therefore be implemented at a third discrete dimming level.

In this example, it may be desired that the first current and the second current are identical.

In the examples provided, the controller C may base the number of discrete dimming levels on the number of drivers provided in the driver circuit. In the example of drivers having identical rated powers, the number of discrete dimming levels may be determined by the equation: D=1+N, where D is the number of discrete dimming levels and N is the number of drivers. In the example where two drivers are provided, the number of discrete dimming levels is 3. The dimming signal has a dimming range from 0% to 100%. The controller C reads the dimming signal and based on the value of the dimming signal, discrete dimming levels are generated. The discrete dimming levels are then set at 0% output power, 50% output power and 100% output power. In this example, a dimming signal between 0% and 25% may be converted into 0% as a discrete dimming level. A dimming signal between 26% and 75% may be converted into 50% as a discrete dimming level. A dimming signal between 76% and 100% may be converted into 100% as a discrete dimming level. It is clear that these values are merely one example of how to convert the dimming range of the dimming signal into discrete dimming levels and that other ranges for converting the dimming signal into the discrete dimming levels are conceivable. At 0% output power, the controller provides control signals to the drivers preventing the first driver D1 and the second driver D2 to provide power to the light source. Both drivers may be turned off. At 50% of the output power, the controller C provides control signals to the drivers allowing one of the drivers to provide the rated power to the load and preventing the other driver to provide power to the load. Preferably, the first driver D1 may provide power to the first sub-load LED1, and the second driver D2 may not provide any power to the light source. Alternatively, the second driver D2 may provide power to the second sub-load LED2, and the first driver D1 may not provide any power to the light source. At 100% of the output power, the controller C provides control signals to the drivers allowing both drivers to provide their rated power to the light source.

In the examples provided, the controller C may base the number of discrete dimming levels on the number of drivers provided in the driver circuit. In the example of drivers having different rated powers, the number of discrete dimming levels may be derived from the equation

$$D = \frac{N ( N + 1 )}{2} + 1 ,$$

where D is the number of discrete dimming levels and N is the number of drivers. In the example where two drivers are used, the number of discrete dimming levels is four. As an example, the first driver D1 is arranged to have a rated power of 1 W and the second driver D2 is arranged to have a rated power of 3 W. When both drivers are not providing power to the light source, the power to the light source is 0 W, which is related to a dimming level between 0% and 24%. When only the first driver D1 provides power to the light source at its rated power, the light source receives 1 W, which corresponds to 25% of the total output power. Preferably, the first driver D1 provides the 1 W of power to the first sub-load LED1. Preferably, the first sub-load LED1 has an optimum light generation at 1 W. The current provided by the first driver D1 may provide a current density for the first sub-load LED1 that is close to the optimum current density for the first sub-load LED1. This output power is then related to a dimming level between 25% and 50%. When only the second driver D2 provides power to the light source at its rated power, the light source receives 3 W, which corresponds to 75% of the total output power. This output power is then related to a dimming level between 51% and 75%. Preferably, the second driver D2 provides the 3 W of power to the second sub-load LED2. Preferably, the second sub-load LED2 has an optimum light generation at 3 W. The current provided by the second driver D2 may provide a current density for the second sub-load LED2 that is close to the optimum current density for the second sub-load LED2. The total rated power of the sum of the drivers is 4 W, which corresponds to the output power at a dimming level between 76% and 100%, where both the first driver D1 and the second driver D2 provide power to the light source at their respective rated powers.

In the examples provided, the controller C, and additional peripheral electrical components, may also be powered using a dedicated power supply. An auxiliary power supply may be provided that is used to power the controller C. Preferably, the auxiliary power supply is electrically isolated from the light source. The auxiliary power supply is therefore a dedicated power supply for the controller C. The auxiliary power supply is not able to provide power to the light source and therefore can be optimized for powering the controller C.

During a stand-by mode of the lighting apparatus, no power is to be provided to the light source and therefore the drivers can be turned off. The controller C may however be required to operate in a stand-by mode for e.g. receiving control commands for activating the lighting apparatus. The controller C then requires less power than during the operation mode of the lighting apparatus. A further auxiliary power supply may be provided to power the controller C and peripheral electrical components during the standby. The further auxiliary is optimized for powering the controller C in the stand-by mode.

Under the definition of rated power, it could be understood that the driver has a defined power capability. At this power capability, the driver provides the power to the light source in a most efficient way. The driver's design is then optimized to allow the highest efficiency to be achieved at this rated power level. The rated power may be at a power that is at the maximum power that the driver can provide. Alternatively, the rated power may be below the maximum power level. When the driver provides a power that is different from the rated power, e.g. higher or lower than the rated power, the efficiency of the driver will be reduced. For maximum efficiency, it is therefore desired to operate the driver at its rated power whenever the driver is required to provide power to the light source.

In the examples provided the drivers may be separate devices with separate components. To improve the use of space and components, some components may be re-used among the drivers.

In the examples provided, the dimming levels relate linearly with the power required for the light source. Other relations such as a logarithmic or non-linear may also be conceivable and lead to the desired effects.

In the examples provided, for the sake of simplicity, the discrete dimming levels are evenly distributed over the entire dimming range. It is to be understood that this is merely one option of converting the dimming level into discrete dimming levels. Alternatively, the discrete dimming levels may be distributed such that at a low dimming sub-range, more discrete dimming levels are provided than at a high dimming sub-range, or vice versa.

As a definition of a dimming level, it is understood how much of the power is required to be provided to the load by the driver circuit. At a dimming level of 100%, It is desired that the driver circuit provides 100% of its rated power. At a dimming level of 0%, it is desired that the driver circuit provides 0% of its rated power. The dimming levels in between 100% and 0% can be scaled linear or non-linear to the rated power of the driver circuit. In a linear scaling, a dimming level of 50% may relate to 50% of the rated power of the driver circuit. In a non-linear scaling, a dimming level of 50% may e.g. relate to 25% of the rated power of the driver circuit.

The examples provided show the use of two drivers or three drivers. It is clearly to be understood that more drivers can be used. Furthermore, the more drivers are used, the more discrete dimming levels can be provided.

The examples provided show switching elements as a MOSFET but other type of switching elements are also possible. Examples of switching elements are transistors and relays.

The drivers may be provided as switched mode power supplies. Examples of switched mode power supplies are boost converters, buck converters, buck-boost converters, flyback converter or resonant converters. Instead of operating the switching element as a switch that is open or closed, the switching element may also be operated in its linear operating regime. This allows better control of power distribution between the sub-loads.

The light source may be considered as a single light source, having an input and a return. The drivers provide power to the input and return.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A lighting apparatus comprising:
a light source having an input and an output and a parallel or a series configuration of a first sub-load and a second sub-load coupled between the input and the output;
a first driver adapted to provide power to the input of the light source;
a second driver adapted to provide power to the input of the light source;
a controller adapted to receive a dimming signal and adapted to allow or deny a power to be provided by the first driver and/or the second driver to the light source based on the dimming level; and
a control circuit adapted to receive a control signal, wherein the control circuit is arranged to activate and deactivate the first sub-load and the second sub-load based on the control signal.

2. The lighting apparatus of claim 1, wherein the light source comprises a third sub-load and wherein the lighting apparatus comprises a third driver adapted to provide power to the light source, wherein the controller is further adapted to allow or deny power to be provided by the third driver, wherein the control circuit is further arranged to activate and deactivate the third sub-load.

3. The lighting apparatus according to claim 1, wherein the control signal is provided by the controller.

4. The lighting apparatus according to claim 1, wherein the controller is arranged to allow power of the first driver to be provided to the light source and deny power of the second driver to be provided to the light source at a first dimming level.

5. The lighting apparatus according to claim 4, wherein the control circuit is arranged to activate the first sub-load and deactivate the second sub-load.

6. The lighting apparatus according to claim 1, wherein a current provided by the first driver corresponds to an optimal current density of the first sub-load.

7. The lighting apparatus according to claim 1, wherein the controller is arranged to deny power of the first driver to be provided to the light source and allow power of the second driver to be provided to the light source at a second dimming level.

8. The lighting apparatus according to claim 7, wherein the control circuit is arranged to deactivate the first sub-load and activate the second sub-load.

9. The lighting apparatus according to claim 1, wherein a current provided by the second driver corresponds to an optimal current density of the second sub-load.

10. The lighting apparatus according to claim 1, wherein a maximum power capability of the first driver is approximately identical to a maximum power capability of the second driver.

11. The lighting apparatus according to claim 1, wherein a maximum power capability of the first driver is lower than a maximum power capability of the second driver.

12. The lighting apparatus according to claim 1, wherein the first driver and the second driver are non-dimmable drivers.

13. The lighting apparatus according to claim 1, wherein light generated by the first sub-load is emitted at a first surface and light generated by the second sub-load is emitted at a second surface, wherein the first surface at least partly does not overlap with the second surface.

14. The lighting apparatus according to claim 1, wherein light generated by the first sub-load has a different color or color temperature as light generated by the second sub-load.

15. The lighting apparatus according to claim 1, wherein the first sub-load and/or the second sub-load comprise an LED light source.
